(19) United States
(12) Patent Application Publication
(10) Pub. No.: US 2006/0277322 A1
(43) Pub. Date: Dec. 7, 2006

(54) System and method for implementing reference-based electronic mail compression

(75) Inventor: Zhigang Liu, Coppell, TX (US)

Correspondence Address: FOLEY & LARDNER LLP, 321 NORTH CLARK STREET, SUITE 2800, CHICAGO, IL, 60610-4764, US

(73) Assignee: Nokia Corporation

(21) Appl. No.: 11/145,069

(22) Filed: Jun. 3, 2005

(51) Int. Cl. G06F 15/16

(52) U.S. Cl. 709/246; 709/206

(57) ABSTRACT

A system and method for transmitting content such as electronic mail from a sending electronic device to a recipient electronic device. When content is to be sent, it is first determined whether the sending electronic device possesses a reference content item that has redundancy with the current content item. If so, it is determined whether the recipient electronic device includes a copy of the reference content item. If the recipient electronic device possesses a copy of the reference content item, a compression algorithm is used to compress the current content item, with the compression being based upon the reference content item existing in both the sending electronic device and the recipient electronic device. The compressed current content item is then transmitted to the recipient device, where it is decompressed and made available.

### FIELD OF THE INVENTION

The present invention relates generally to synchronization of content between electronic devices. More particularly, the present invention relates to the efficient synchronization of electronic mail messages between an electronic mail client and a server.

### BACKGROUND OF THE INVENTION

The Internet Engineering Task Force (IETF) has standardized a number of different protocols for the synchronization of electronic mail. These protocols include (1) Simple Mail Transfer Protocol (SMTP, RFC 2821) for reliable electronic mail transfer between a client and a server; (2) Post Office Protocol—Version 3 (POP, RFC 1939) for a client downloading electronic mail messages from a server; and (3) Internet Message Access Protocol—Version 4, Rev. 1 (IMAP4rev1, RFC 3501), which permits a client to access and manipulate electronic mail messages on a server, as well as allowing an offline client to resynchronize with the server.

The above-identified protocols were each originally designed in the context of fixed line networks. In fixed-line networks, bandwidth is often not a critical issue, as such networks usually have a great deal of bandwidth and the cost associated with the bandwidth is often reasonable. However, as electronic mail, like many other Internet-based applications, become more and more usable in mobile networks, an electronic mail client may communicate with a server over a wireless link that has a very limited and/or expensive bandwidth. In such systems, efficiency in electronic mail synchronization becomes more important than it traditionally has been in fixed-line networks.

Compression is one way to improve electronic mail synchronization efficiency. Compression is a reversible conversion of data into a format that requires fewer bits. Compression is usually performed so that the data can be stored or transmitted more efficiently than in conventional systems, as it reduces the amount of data that needs to be transmitted between a client device and server. Unfortunately, currently existing compression methods are not specifically designed for electronic mail applications.

### SUMMARY OF THE INVENTION

This present invention involves an improved compression method that achieves superior performance by utilizing the characteristic of electronic mail applications and the features provided by electronic mail protocols. The present invention involves the introduction of a mechanism to use previously transferred electronic mail messages in order to compress a current electronic mail message that is to be transferred. The mechanism utilizes the properties of various existing electronic mail protocols between an electronic mail client and server. It also includes extensions (e.g. query) to the protocols to ensure successful compression and decompression.

The present invention can lead to a significant boost in compression ratio. Increased compression ratios result in significantly less data having to be transferred in order to accomplish synchronize between an electronic mail client and a server, which results in an improved end user experience. A higher compression ratio also means that less data needs to be synchronized, reducing the network load and increasing the number of users that can be supported by the service provider. The optimization resulting from the present invention is transparent to an end user, and the present invention can be applied to existing generic compression algorithms, such as DEFLATE and other algorithms in the family of Lempel-Ziv coding. Lastly, the implementation of the present invention only requires a small amount of coding, since most electronic mail clients and servers already have a compression library (e.g. zlib) available or can download such a compression library from open sources. Therefore, the implementation of the present invention only requires the implementation of the basic logic, and the library is then called to perform the actual compression. The present invention can also be implemented as either a proprietary system or part of a standardized optimization.

These and other objects, advantages and features of the invention, together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is an overview diagram of a system within which the present invention may be implemented;

FIG. 2 is a perspective view of a mobile telephone that can be used in the implementation of the present invention;

FIG. 3 is a schematic representation of the telephone circuitry of the mobile telephone of FIG. 2;

FIG. 4 is a representation of plurality of electronic mail messages, showing the significant redundancy that occurs between individual messages;

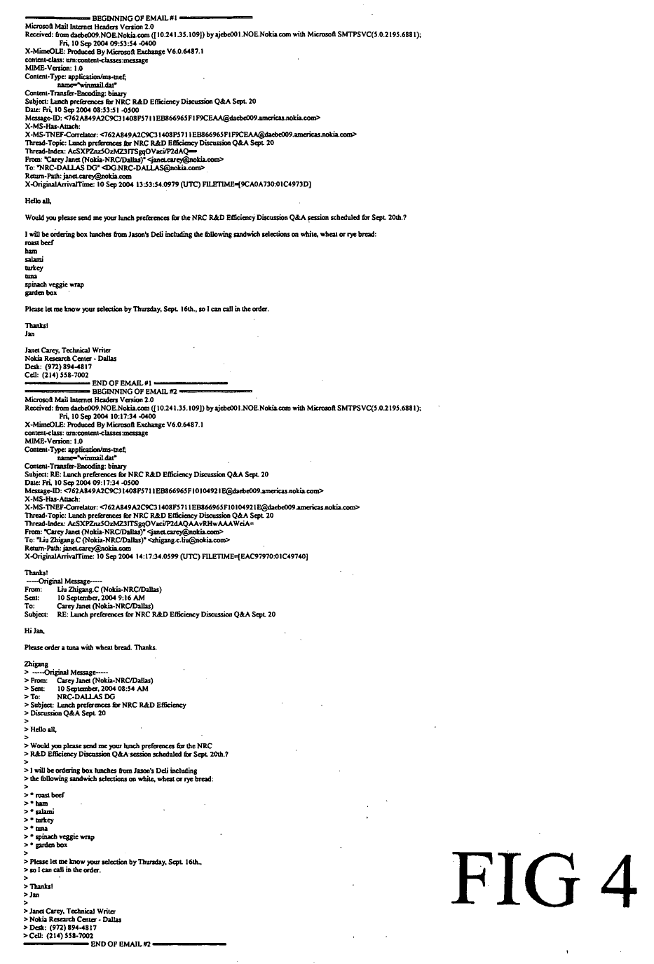

FIG. 5 is a representation of a typical protocol stack for an en electronic mail client and a server;

FIG. 6 is a flow chart showing the implementation of one embodiment of the present invention from a sender's point of view; and

FIG. 7 is a flow chart showing the implementation of one embodiment of the present invention from a recipient's point of view.

### DETAILED DESCRIPTION OF THE INVENTION

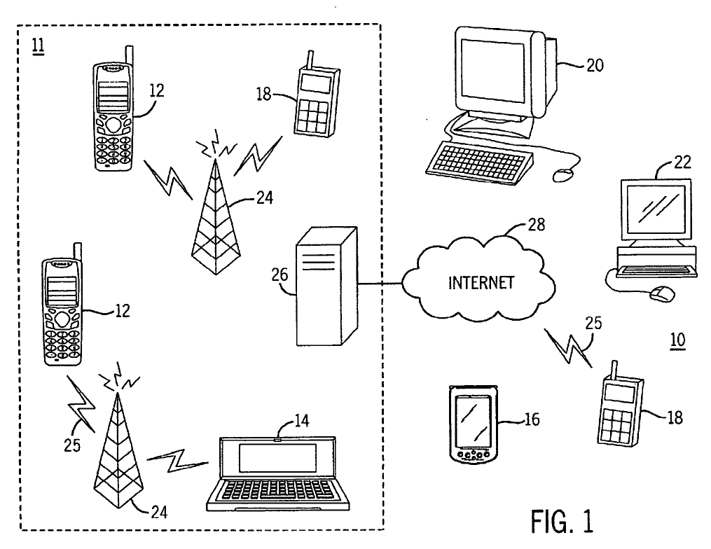

FIG. 1 shows a system 10 in which the present invention can be utilized, comprising multiple communication devices that can communicate through a network. The system 10 may comprise any combination of wired or wireless networks including, but not limited to, a mobile telephone network, a wireless Local Area Network (LAN), a Bluetooth personal area network, an Ethernet LAN, a token ring LAN, a wide area network, the Internet, etc. The system 10 may include both wired and wireless communication devices.

For exemplification, the system 10 shown in FIG. 1 includes a mobile telephone network 11 and the Internet 28. Connectivity to the Internet 28 may include, but is not limited to, long range wireless connections, short range wireless connections, and various wired connections including, but not limited to, telephone lines, cable lines, power lines, and the like.

The exemplary communication devices of the system 10 may include, but are not limited to, a mobile telephone 12, a combination PDA and mobile telephone 14, a PDA 16, an integrated messaging device (IMD) 18, a desktop computer 20, and a notebook computer 22. The communication devices may be stationary or mobile as when carried by an individual who is moving. The communication devices may also be located in a mode of transportation including, but not limited to, an automobile, a truck, a taxi, a bus, a boat, an airplane, a bicycle, a motorcycle, etc. Some or all of the communication devices may send and receive calls and messages and communicate with service providers through a wireless connection 25 to a base station 24. The base station 24 may be connected to a network server 26 that allows communication between the mobile telephone network 11 and the Internet 28. The system 10 may include additional communication devices and communication devices of different types.

The communication devices may communicate using various transmission technologies including, but not limited to, Code Division Multiple Access (CDMA), Global System for Mobile Communications (GSM), Universal Mobile Telecommunications System (UMTS), Time Division Multiple Access (TDMA), Frequency Division Multiple Access (FDMA), Transmission Control Protocol/Internet Protocol (TCP/IP), Short Messaging Service (SMS), Multimedia Messaging Service (MMS), e-mail, Instant Messaging Service (IMS), Bluetooth, IEEE 802.11, etc. A communication device may communicate using various media including, but not limited to, radio, infrared, laser, cable connection, and the like.

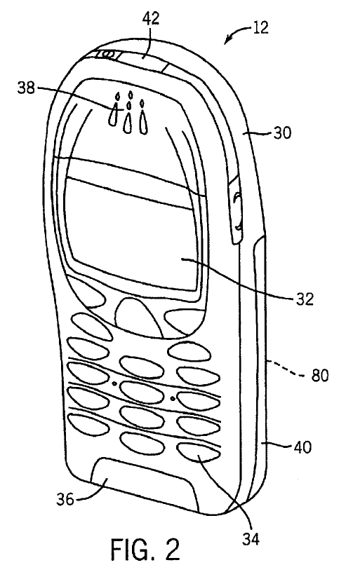

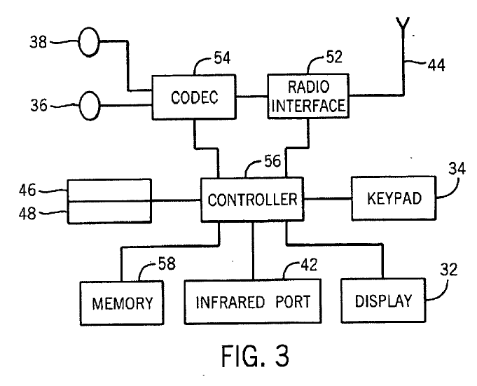

FIGS. 2 and 3 show one representative mobile telephone 12 within which the present invention may be implemented. It should be understood, however, that the present invention is not intended to be limited to one particular type of mobile telephone 12 or other electronic device. The mobile telephone 12 of FIGS. 2 and 3 includes a housing 30, a display 32 in the form of a liquid crystal display, a keypad 34, a microphone 36, an ear-piece 38, a battery 40, an infrared port 42, an antenna 44, a smart card 46 in the form of a UICC according to one embodiment of the invention, a card reader 48, radio interface circuitry 52, codec circuitry 54, a controller 56 and a memory 58. Individual circuits and elements are all of a type well known in the art, for example in the Nokia range of mobile telephones.

The present invention introduces a mechanism to use previously-transferred electronic mail messages as a guide to compress a current electronic mail message that is to be transferred. The system of the present invention utilizes the properties of various existing electronic mail protocols between an electronic mail client and a server. The present invention also includes extensions such as “query” to the protocols to ensure successful compression and decompression.

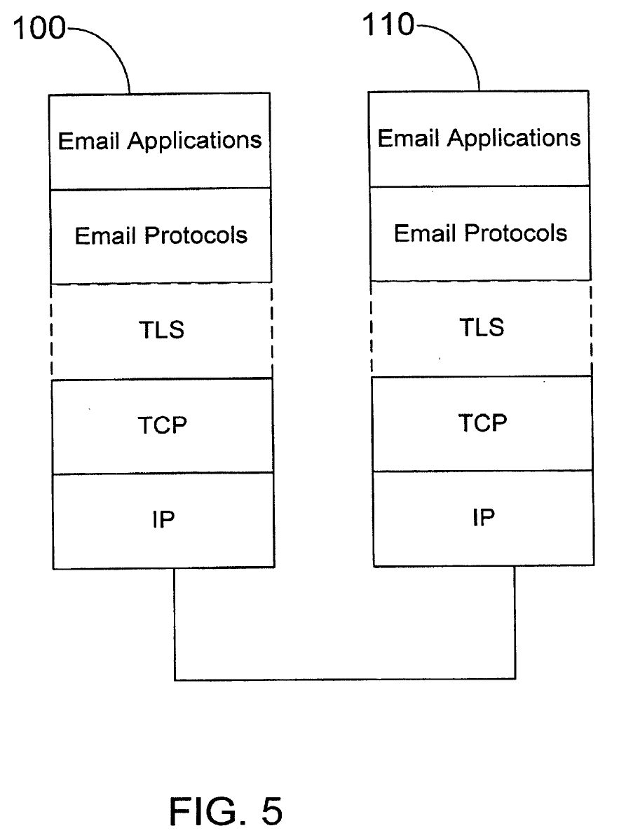

The present invention is primarily based on two basic issues with electronic mail messages. First, electronic mail messages tend to have a great deal of redundancy between each other. A typical electronic mail communication, particularly in an enterprise environment, includes a sequence of electronic mail messages exchanged on the same subject among a group of people. These electronic mail messages will possess similar electronic mail header fields. These fields typically include people's names, electronic mail addresses, and a subject heading. More importantly, the body of an electronic mail message that is in reply to another electronic mail message usually contains all or portions of the prior message. Those portions can be compressed by using the prior message as a reference. These features can be clearly observed in FIG. 5.

Second, in many electronic mail applications, a client and a server possess the same copy of previously-exchanged electronic mail messages that can be used as references to compress messages for later exchanging. For example, most electronic mail client software supports an offline feature, where the electronic mail client maintains a local snapshot of its mailbox on the server. This allows a user to read and process his or her electronic mail messages while not connected with networks. This is a particularly useful feature for mobile users in situations where, for example, a user is travelling on a plane or staying in a location that has no secure connection to a home network.

The implementation of the present invention is generally as follows. It should be noted that, in terms of the discussion herein, the sender and receiver can comprise either an electronic mail client or an electronic mail server, depending on which direction a particular electronic mail message is being transmitted.

FIG. 5 is a representation of a simplified client/server protocol stack according to one embodiment of the present invention. An electronic mail client 100 and an electronic mail server 110 each include (1) one or more electronic mail applications; (2) electronic mail protocols; (3) transport layer security (TLS), which may be an optional feature; (4) a transmission control protocol (TCP); and an Internet Protocol (IP). The electronic mail protocols can take a variety of forms, including SMTP, IMAP; and post office protocol, version 3 (POP3).

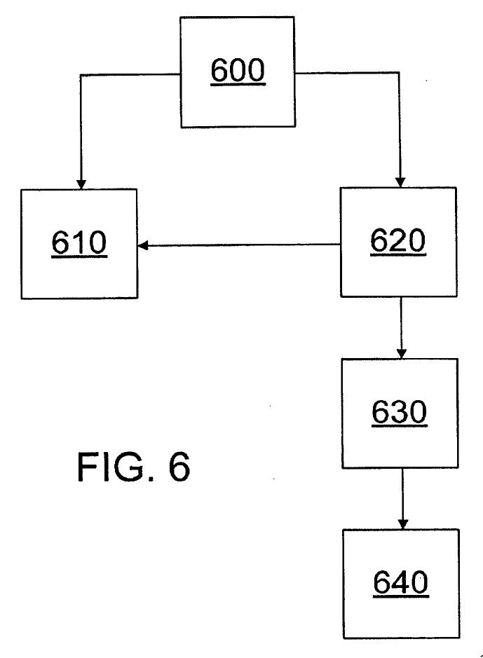

FIG. 6 is a flow chart showing the procedure involved in the sending of an electronic mail message according to the present invention. When a sender needs to transmit an electronic mail message, the sender first decides if a reference-based electronic mail compression should be used. At step 600, the sender determines whether it has electronic mail messages in its local storage that have redundancy with the current electronic mail message to be sent. If the result is that there are no such messages in local storage, then the message is sent in either an uncompressed form or a compressed form but without any reference at step 610. This can be accomplished in a number of different ways. For example, electronic mail messages belonging to the same thread usually have significant redundancy between each other. An electronic mail thread can therefore be identified by electronic mail header fields such as “Subject,” “In-Reply-To,” “References,” “Thread-Topic,” “Thread-Index,” or any combination of thereof.

If, on the other hand, the sender's local storage includes electronic mail messages with redundancies, the sender determines at step 620 whether the recipient possesses a copy of at least one of the reference electronic mail messages in the recipient's local storage. If the recipient does not possess any of the referenced electronic mail messages, then the electronic mail message is transmitted at step 610 in either an uncompressed form or a compressed form without any reference.

With some electronic mail protocols and modeling, a sender can determine whether or not the recipient has a particular electronic mail message without an explicit query as described in step 620. For example, if the IMAP protocol is used for an electronic mail client 100 to access its mailbox on an electronic mail server 110, the electronic mail client 100 maintains full control of the mailbox content, except for new electronic mail messages sent to the electronic mail client 100 that have arrived since the last time the electronic mail client 100 synchronized with the electronic mail server 110. Therefore, the electronic mail client 100 can know which electronic mail messages have been stored in the mailbox up to the last synchronization by keeping a local log of unique identifiers of electronic mail messages in the mailbox. This log must not contain electronic mail messages that the electronic mail client 100 has already deleted from the mailbox. In the server-to-client direction, this is slightly more complicated because the electronic mail client 100, if serving as the recipient, may delete a previously received electronic mail message from its local storage without notifying the electronic mail server 110.

In the event that the sender does not know which electronic mail messages the receiver possesses, the sender can send a query to the recipient to determine if the recipient has any copies of the selected reference electronic mail messages. This query contains a list of unique identifiers for the selected messages. The identifiers can be same identifiers as used in the electronic mail protocols, or the identifiers specified in the Internet message format. Many electronic mail protocols provide a mechanism for uniquely identifying an electronic mail message. For example, IMAP specifies that combination of mailbox name, UIDVALIDITY (a 32-bit value) and UID (a 32-bit value) must refer to a single immutable message on the electronic mail server 110 forever. POP3 also assigns a message number to each electronic mail message after it opens a mailbox. However, the message-numbers are only unique within a POP3 session. In addition, Internet message format (RFC 2822) defines a “Message-ID” field in electronic mail message headers which provides a unique message identifier that refers to a particular version of a particular message.

Instead of using predesignated identifiers, the sender and the receiver can also agree to use their own message identifier, for example, a checksum, cyclic redundancy code (CRC) or hash over an electronic mail message. In this case, the checksum/CRC/hash should be long enough to reduce the possibility of collision, where two different electronic mail messages produce the same checksum/CRC/hash value. Another method involves combining the electronic mail origination date and time with the checksum/CRC/hash in order to identify an electronic mail message.

If the recipient device includes an electronic mail reference message, then at step 630 the sender compresses the current electronic mail message using the selected reference message. Commonly used data compression algorithms, such as Lempel-Ziv, supports or can be made to support reference based compression. The exact encoding format depends upon the compression algorithm and the implementation choice, such as at which layer the compression is implemented. One option for implementation involves encoding the indications as part of an electronic mail message. For example, a MESSAGE-TYPE can be carried at the beginning of each electronic mail message (either compressed or uncompressed). If the message is compressed, an ALGORITHM indicator is carried. If the compressed message uses a reference, a REFERENCE indicator is carried. A second option involves sending the indications as part of an electronic mail protocol or extensions to the electronic mail protocol. Usually, an electronic mail protocol defines requests and replies that must be exchanged between a sender and a recipient before an electronic mail message can actually be transmitted. These indications can be signaled as parameters of those requests and replies.

Some basic requirements for identifiers include the following.

MESSAGE-TYPE: the sender must have a mechanism to indicate whether an electronic mail message is compressed or not, and if so, whether the electronic mail message is compressed using a reference. This allows for the multiplexing of all types of electronic mail messages that may need to be exchanged between a sender and a receiver. For example, a sender may decide not to compress an electronic mail message using a reference, or the sender may decide not to compress the message at all.

REFERENCE: The sender must have a mechanism to indicate to the receiver which electronic mail message was used as the reference for compressing the current electronic mail message. This can be accomplished, for example, by sending a form of identifier of the reference electronic mail message to the receiver.

ALGORITHM: If multiple compression algorithms are permitted to be used between the sender and the receiver, the sender must indicate which algorithm was used to compress the current electronic mail message.

To add robustness, the compressed electronic mail message may also carry a CRC, checksum or hash over the original uncompressed electronic mail message. This allows the receiver to verify, after decompression, whether the decompressed electronic mail message is exactly the same as the original message sent by the sender.

At step 640, the sender transmits the compressed message to the receiver. In most instances, electronic mail messages are transmitted over reliable communication channels such as TCP. Therefore, message loss and/or corruption during transmission does usually not need to be addressed.

If the recipient device receives a query concerning the existence of certain reference emails from the sender, it must reply by confirming which reference emails it has in its possession at that particular moment and for how long it can guarantee the emails' existence (in, for example, minutes, hours or days). The recipient device then locks those emails and does not delete them for the promised duration. In the rare situation where the recipient receives a local request to delete a locked email (e.g., a user instructs his or her own device to delete the email), then the recipient device performs a logical deletion, making it appear to the user through an interface that the email has been deleted while maintaining a physical copy of the email until the promised holding during has passed. This process ensures that the reference email is available during the time window between the query and the actual decompression as discussed below.

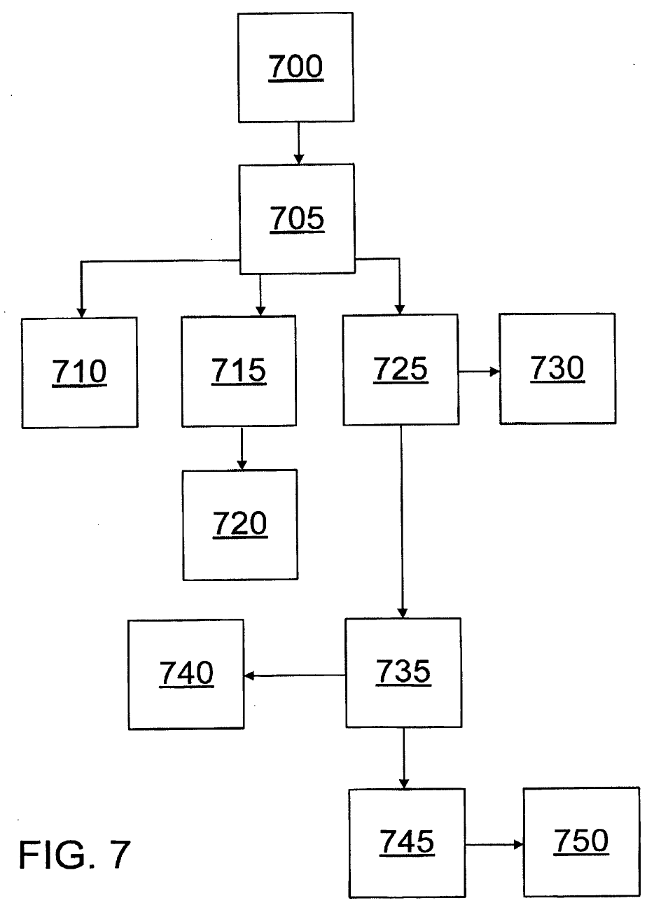

A flow chart showing the procedure for implementing one embodiment of the present invention from the recipient's point of view is shown in FIG. 7. At step 700, the recipient receives an electronic mail message from the sender. At step 705, the recipient determines whether the electronic mail message is compressed, and if so, whether the electronic mail message is compressed using a reference. If the electronic mail message is uncompressed, then the recipient delivers it to an upper layer or user directly at step 710. If the electronic mail message is compressed without using a reference, then the recipient decompresses the message at step 715 and then delivers it to an upper layer or to the user at step 720.

If the electronic mail message was compressed using a reference, then at step 725, the recipient retrieves the reference electronic mail message from its local storage, if the reference message can be located. In the event that the recipient cannot locate the reference electronic mail message, then it sends a REFERENCE-NOT-FOUND error message back to the sender at step 730. Upon receiving the error message REFERENCE-NOT-FOUND or DECOMPRESSION-FAILED from the recipient, the sender resends the electronic mail message that triggered the error, either in uncompressed or in a compressed form but without using any reference. The sender also records the corresponding reference message ID so that it will not be used as a reference for future compression. These steps occur even if the sender only receives a DECOMPRESSION-FAILED error in one embodiment of the invention, because the reference electronic mail message might be corrupted on the recipient side, and the recipient may not detect the corruption.

After the recipient receives the compressed message including the reference, the recipient performs decompression. If the compressed electronic mail message carries CRC/checksum/hash of the original message, the receiver calculates the corresponding value over the decompressed message and compares it with the value carried in the compressed message at step 735. If the two values do not match, the decompression fails and the receiver sends a DECOMPRESSION-FAILED error message back to the sender at step 740. If the two values match, then the decompression succeeds and is completed at step 745. At step 750, the decompressed electronic mail message is delivered either to the user or to the upper layer of the protocol stack.

In some electronic mail application models, an electronic mail server 110, acting as the sender, may not have a local electronic mail message to use as a reference. For example, an Internet service provider (ISP) may require its electronic mail servers to delete electronic mail messages once they are downloaded to electronic mail clients. In such a situation, the reference-based electronic mail compression cannot be used on the direction from the electronic mail server 110 to the electronic mail client 100. However, many ISP service providers allow the users to decide whether to delete electronic mail messages on the server side. This is a typical configuration for most enterprise environments.

It should be noted that the present invention can be implemented at different layers in the respective electronic devices. Although the present invention is discussed herein in terms of the electronic mail protocol layer, the present invention can also be implemented above the electronic mail protocol layer. For example, the invention can be implemented as a feature of the electronic mail application or software running on top of electronic mail protocols. This implementation can avoid adding additional extensions to existing electronic mail protocols. However, this arrangement still requires pre-agreement between the applications.

The present invention can be implemented either as a standardized method or as a proprietary optimization. A proprietary optimization allows for faster deployment in products.

It should also be noted that an electronic mail message may pass through a number of intermediate relay or gateway hosts on its path from the original sender to the ultimate recipient. These hosts act as a client device when sending the electronic mail and a server when receiving it. The method described in the present invention is thus applicable to each hop on the path when appropriate.

The present invention is described in the general context of method steps, which may be implemented in one embodiment by a program product including computer-executable instructions, such as program code, executed by computers in networked environments. Generally, program modules include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps.

Software and web implementations of the present invention could be accomplished with standard programming techniques with rule based logic and other logic to accomplish the various database searching steps, correlation steps, comparison steps and decision steps. It should also be noted that the words “component” and “module,” as used herein and in the claims, is intended to encompass implementations using one or more lines of software code, and/or hardware implementations, and/or equipment for receiving manual inputs.

The foregoing description of embodiments of the present invention have been presented for purposes of illustration and description. It is not intended to be exhaustive or to limit the present invention to the precise form disclosed, and modifications and variations are possible in light of the above teachings or may be acquired from practice of the present invention. The embodiments were chosen and described in order to explain the principles of the present invention and its practical application to enable one skilled in the art to utilize the present invention in various embodiments and with various modifications as are suited to the particular use contemplated.

What is claimed is:

1. A method of transmitting a current content item from a sending electronic device to a recipient electronic device, comprising:
determining whether the sending electronic device possesses a reference content item that has redundancy with the current content item;
if the sending electronic device possesses a reference content item that has redundancy with the current content item, determining whether the recipient electronic device includes a copy of the reference content item;
if the recipient electronic device possesses a copy of the reference content item, using a compression algorithm to compress the current content item, the compression based upon the reference content item existing in both the sending electronic device and the recipient electronic device; and
transmitting the compressed current content item to the recipient device.

2. The method of claim 1, wherein the determining whether the recipient electronic device includes a copy of the reference content item comprises transmitting a query to the recipient electronic device asking whether the recipient electronic device includes a copy of the reference content item.

3. The method of claim 2, wherein the query includes at least one unique identifier for the reference content item.

4. The method of claim 1, wherein the determining whether the recipient electronic device includes a copy of the reference content item comprises identifying content that has been transmitted to the recipient electronic device up to the last time that that sending electronic device has synchronized with the recipient electronic device.

5. The method of claim 1, further comprising, if the sending electronic device does not possess content that has redundancy with the current content item, transmitting the current content item to the recipient device in either an uncompressed form or a compressed form but without any reference.

6. The method of claim 1, further comprising, if the recipient electronic device does not possess a copy of the reference content item, transmitting the current content item to the recipient device in either an uncompressed form or a compressed form but without any reference.

7. The method of claim 1, wherein the current content item and the reference content items comprise electronic mail messages.

8. A computer program product for transmitting a current content item from a sending electronic device to a recipient electronic device, comprising:
computer code for determining whether the sending electronic device possesses a reference content item that has redundancy with the current content item;
computer code for, if the sending electronic device possesses a reference content item that has redundancy with the current content item, determining whether the recipient electronic device includes a copy of the reference content item; and
computer code for, if the recipient electronic device possesses a copy of the reference content item, using a compression algorithm to compress the current content item and transmitting the compressed current content item to the recipient device, the compression based upon the reference content item existing in both the sending electronic device and the recipient electronic device.

9. The computer program product of claim 8, wherein the determining whether the recipient electronic device includes a copy of the reference content item comprises transmitting a query to the recipient electronic device asking whether the recipient electronic device includes a copy of the reference content item.

10. The computer program product of claim 8, further comprising computer code for, if the sending electronic device does not possess content that has redundancy with the current content item, transmitting the current content item to the recipient device in either an uncompressed form or a compressed form but without any reference.

11. The computer program product of claim 8, further comprising computer code for, if the recipient electronic device does not possess a copy of the reference content item, transmitting the current content item to the recipient device in either an uncompressed form or a compressed form but without any reference.

12. An electronic device, comprising:
a processor; and
a memory unit operatively connected to the processor and including:
computer code for determining whether the sending electronic device possesses a reference content item that has redundancy with the current content item;
computer code for, if the sending electronic device possesses a reference content item that has redundancy with the current content item, determining whether the recipient electronic device includes a copy of the reference content item; and
computer code for, if the recipient electronic device possesses a copy of the reference content item, using a compression algorithm to compress the current content item and transmitting the compressed current content item to the recipient device, the compression based upon the reference content item existing in both the sending electronic device and the recipient electronic device.

13. The electronic device of claim 12, wherein the determining whether the recipient electronic device includes a copy of the reference content item comprises transmitting a query to the recipient electronic device asking whether the recipient electronic device includes a copy of the reference content item.

14. The electronic device of claim 12, wherein the memory unit further comprises computer code for, if the sending electronic device does not possess content that has redundancy with the current content item, transmitting the current content item to the recipient device in either an uncompressed form or a compressed form but without any reference.

15. The electronic device of claim 12, wherein the memory unit further comprises computer code for, if the recipient electronic device does not possess a copy of the reference content item, transmitting the current content item to the recipient device in either an uncompressed form or a compressed form but without any reference.

16. A method for processing a current content item from a sending electronic device, comprising:
receiving the current content item from the sending electronic device;
determining if the current content item is in compressed form;
if the current content item is in compressed form, determining whether the current content item is in compressed form using a reference;
if the current content item is in compressed form using a reference content item, attempting to retrieve a reference content item; and
if the attempt to retrieve the reference item is successful, using the reference content item to decompress the current content item for use.

17. The method of claim 16, further comprising, if the current content item is not in compressed form using a reference, decompressing the current content item for use.

18. The method of claim 16, further comprising, if the attempt to retrieve a reference content item fails, transmitting an error message to the sending electronic device.

19. A computer program product for processing a current content item from a sending electronic device, comprising:
computer code for receiving the current content item from the sending electronic device;
computer code for determining if the current content item is in compressed form;
computer code for, if the current content item is in compressed form, determining whether the current content item is in compressed form using a reference;
computer code for, if the current content item is in compressed form using a reference content item, attempting to retrieve a reference content item; and
computer code for, if the attempt to retrieve the reference item is successful, using the reference content item to decompress the current content item for use.

20. The computer program product of claim 19, further comprising computer code for, if the current content item is not in compressed form using a reference, decompressing the current content item for use.
